(19) United States
(12) Patent Application Publication
(10) Pub. No.: US 2019/0357650 A1
(43) Pub. Date: Nov. 28, 2019

(54) PACKING BOXES

(71) Applicant: Yungu (Gu'an) Technology Co., Ltd., Langfang (CN)

(72) Inventors: Fu LIAO, Kunshan (CN); Qi SHAN, Kunshan (CN); Liwei DING, Kunshan (CN)

(73) Assignee: Yungu (Gu'an) Technology Co., Ltd., Langfang (CN)

(21) Appl. No.: 16/532,961

(22) Filed: Aug. 6, 2019

Related U.S. Application Data
(63) Continuation of application No. PCT/CN2018/090006, filed on Jun. 5, 2018.

(30) Foreign Application Priority Data
Mar. 31, 2018 (CN) 2018204456040

(51) Int. Cl. A45C 15/00; A45C 11/16; G06F 3/14; G06F 3/023

(52) U.S. Cl. CPC A45C 15/00; G06F 3/023; G06F 3/1446; A45C 11/16

(57) ABSTRACT

A packing box, including a box body and a display screen on the box body, is provided. The box body includes a control module connected to the display screen. The display screen includes at least one sub-display screen for displaying a target frame according to a control command received from the control module.

### FIELD

The application relates to a packing box field.

### BACKGROUND

An existing case may have only a beautiful outer box, which cannot be used to express wishes of a gift giver, and an introduction of what in the case can only be made by a salesperson. This case can only be used as a box having a single function and cannot be used for other purposes. Therefore, it is necessary to provide a packing box to solve the above problem.

### SUMMARY

A main object of the present application is to provide a packing box that can be used not only as a box, but also to display an image and increase a function of the packing box.

To solve the above problem, an exemplary embodiment of the application provides a packing box, the packing box includes a box body and a display screen on the box body.

Wherein the box body includes a control module connected to the display screen; the display screen includes at least one sub-display screen for displaying a target frame according to a control command received from the control module.

Optionally, the box body comprises: at least one screen body supporting plate forming at least a part of an accommodation cavity, and the at least one screen body supporting plate is used for supporting the at least one sub-display screen.

Optionally, the packing box may further include: a cover arranged on the at least one screen body supporting plate.

Optionally, the packing box may further include: a decorative member arranged in the cover for placing an article.

Optionally, the packing box may further include: a decorative member arranged in the accommodation cavity for placing an article.

Optionally, the at least one sub-display screen includes a first sub-display screen and a second sub-display screen, the at least one screen body supporting plate includes a first screen body supporting plate supporting the first sub-display screen and a second screen body supporting plate supporting the second sub-display screen.

Optionally, the first screen body supporting plates and the second screen body supporting plate are connected end-to-end to form the box body, and a horizontal cross section of the box body is heart-shaped.

Optionally, the packing box may further include: a battery arranged in the accommodation cavity which is configured to supply power to the at least one sub-display screen and the control module.

Optionally, the packing box may further include: a communication module arranged in the accommodation cavity and configured to receive information related to the target frame, so that the control module controls the at least one sub-display screen to display the target frame according to the information related to the target frame.

Optionally, the packing box may further include:

a switch button arranged on the box body and used to control display states of the at least one sub-display screen.

The packing box provided in the exemplary embodiments of the present application by using at least one sub-display screen, can display a target frame, and can display characters, frames, and the like to be presented by the gift giver on the sub-display screen, so that the gift giver can directly express his or her own kindness. An design concept, a wearing video etc. of a jewelry placed in the packing box can be displayed on the sub-display screen, so that the jewelry can be known by customers, and sold easily by a seller. A frame, such as text or animation etc., with reminder function for an owner of the jewelry box can also be provided (For example, which day to wear the jewelry, reminding important matters, etc.), thereby adding functions of the box.

### BRIEF DESCRIPTION OF THE DRAWINGS

In order to more clearly illustrate the exemplary embodiments of the application or the technical solutions, the drawings to be used in the exemplary embodiments or the description of the prior art will be briefly described below. Obviously, the drawings in the following description are only some exemplary embodiments of the application, and other drawings may be obtained according to the structures shown in the drawings by a person skilled in the art without paying any creative work.

FIG. 1 is a perspective view of a packing box provided by an exemplary embodiment of the present application;

FIG. 2 is an exploded view of the packing box shown in FIG. 1.

### DETAILED DESCRIPTION

In order to make the objects, the technical solutions and the advantages of the application clear, the technical solutions of the application will be clearly and completely described in the following with reference to the specific exemplary embodiments of the application and the corresponding drawings. It is apparent that the described exemplary embodiments are merely a part of the embodiments of the application rather than all of them. All other embodiments obtained by a person skilled in the art based on the exemplary embodiments of the application without paying creative work fall into the protection scope of the application.

An exemplary embodiment of the application provides a packing box. The packing box includes a box body and a display screen on the box. The box body includes a control module (or called a controller) connected to the display screen; the display screen includes at least one sub-display screen for displaying a target frame according to a control command received from the control module. Preferably, the at least one sub-display screen is a flexible display screen.

In an exemplary embodiment of the present application, the box body includes: at least one screen body supporting plate which forms at least a part of an accommodation cavity and is used for supporting the at least one sub-display screen. In this way, at least one sub-display screen can be better supported, and when at least one sub-display screen is a flexible display screen, a shape of at least one sub-display screen can be set according to a shape of at least one screen body supporting plate. Therefore, at least one sub-display screen can be conveniently set according to the requirements such as aesthetics and reliable structure.

Further, the packing box may further include: a cover arranged on the at least one screen body supporting plate. In this way, a sealed packing box can be conveniently formed.

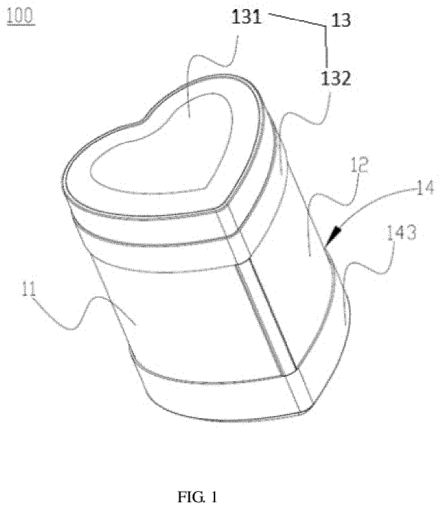

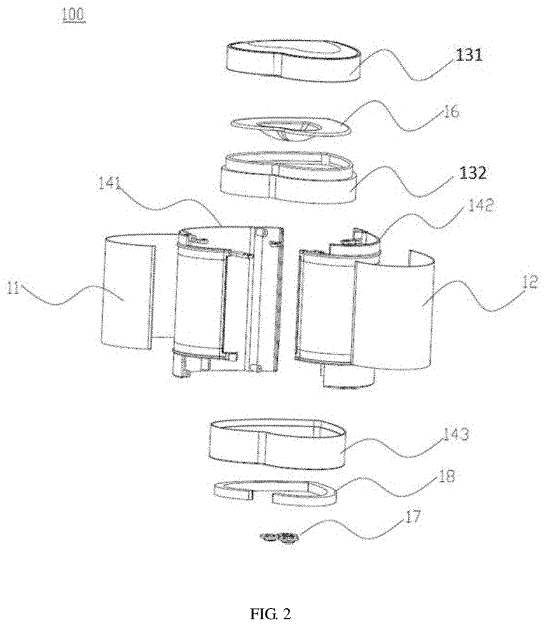

FIG. 1 is a perspective view of a packing box provided by an exemplary embodiment of the present application; and FIG. 2 is an exploded view of the packing box shown in FIG. 1. The packing box provided by the present application will be described below with reference to FIG. 1 and FIG. 2. In an exemplary embodiment of the present application, the sub-display screen and the screen body supporting plate included in the packing box may have a one-to-one correspondence. For example, in FIG. 1 and FIG. 2, the packing box including two sub-display screens which are flexible display screens and two screen body supporting plates is exemplified, however, the present application is not limited thereto. In another exemplary embodiment of the present application, the screen body supporting plate and the sub-display screen included in the packing box may be a one-to-many or a many-to-one relationship. For example, the packing box may include two sub-display screens and one screen body supporting plate, or one sub-display screen and two screen body supporting plates.

The packing box 100 shown in FIG. 1 and FIG. 2 includes: sub-display screens 11 and 12, a cover 13, a box body 14 and a control module (not shown). The box body 14 includes screen body supporting plates 141 and 142, and a bottom 143 connected to the screen body supporting plates. The screen body supporting plate 141 for supporting the sub-display screen 11 and the screen body supporting plate 142 for supporting the sub-display screen 12 form an accommodation cavity. The cover 13 is arranged on the screen body supporting plates 141 and 142. The box body 14 includes a control module that connects the sub-display screens 11 and 12, and the sub-display screens 11 and 12 display a target frame according to a control command received from the control module. Specifically, the control module can control at least one of the sub-display screens 11 and 12 to display the target frame. In this way, since the two sub-display screens are included, the two sub-display screens can display the same content or different contents, which facilitates a diversified display of the packing box. The sub-display screens and the screen body supporting plates are in one-to-one correspondence, which facilitates manufacturing.

As shown in FIG. 1 and FIG. 2, in an exemplary embodiment of the present application, the cover 13 may include: a lower cover 132 arranged on the screen body supporting plates 141 and 142, and an upper cover 131 arranged on the lower cover 132, and the upper cover 131 and the lower cover 132 form an accommodation space.

In an exemplary embodiment of the present application, the packing box 100 may further include: a decorative member 16 for placing articles, and the decorative member 16 is arranged in the accommodation space in the cover 13. The decorative member 16 is for placing an article therein, such as a ring, a bracelet, and the like. In this way, the articles can be presented more beautifully and the decorative member designated for placing the articles is arranged to conveniently facilitate preservation of the articles. Specifically, as shown in FIG. 2, the decorative member 16 is arranged on the lower cover 132.

In another exemplary embodiment of the present application, the decorative member 16 can also be arranged in the accommodation cavity of the box body. For example, the decorative member 16 can be arranged in the accommodation cavity in a snapping manner or a clamping manner, etc. . . .

In the packing box 100 shown in FIG. 1 and FIG. 2, the screen body supporting plates 141 and 142 are connected end-to-end to form the box body 14, and the horizontal cross section of the box body 14 is heart-shaped. In this way, the packing box is heart-shaped, making the shape of the packing box artistic. Then, when the packing box 100 is successfully installed, the two sub-display screens 11 and 12 are respectively arranged on the two screen body supporting plates 141 and 142 for displaying frames. The lower cover 132 of the cover 13 is open at the bottom surface, and the top surface of the box body 14 is provided with a top opening which matches with the bottom opening of the lower cover 132 to form a closed packing box.

In another exemplary embodiment of the present application, the packing box may further include: a battery arranged in the accommodation cavity which is configured to supply power to the at least one sub-display screen and the control module. In this way, the display function of the packing box can be ensured even if an external power supply is not connected.

In another exemplary embodiment of the present application, the packing box may further include: a communication module (or called a communication circuit) arranged in the accommodation cavity and configured to receive information related to the target frame, so that the control module controls the at least one sub-display screen to display the target frame according to the information related to the target frame. The communication module may include a communication interface and a communication module. The communication interface is, for example, a USB interface. The communication module is, for example, a wireless module, for example, a WIFI module, a Bluetooth module, or the like. In this way, the packing box can display the target frame according to real-time needs of the user.

In another exemplary embodiment of the present application, the packing box may further include: a storage module (or called a storage circuit) arranged in the accommodation cavity, and the storage module is configured to store the target frame. In this way, the packing box can display a pre-stored target frame.

In another exemplary embodiment of the present application, the packing box 100 may further include: a switch button 17 arranged on the box body 14 and the switch button 17 is used to control display states of the sub-display screens 11 and 12, specifically, the display states may include an on-state and an off-state. Specifically, as shown in FIG. 2, the switch button is arranged on the bottom 143 of the box. In this way, the display function of the packing box can be switched by a user according to actual needs.

As shown in FIG. 2, in another exemplary embodiment of the present application, the packing box 100 may further include: a foot pad 18 arranged on the bottom 143 of the box. In this way, the wear of the packing box can be reduced.

When the packing box 100 is installed, the display screens 11 and 12 may be respectively attached to the screen body supporting plates 141 and 142. Then, the decorative member 16 is mounted on the cover 13, such elements as a processor, the battery, and the like installed in the accommodation cavity, are connected to the screen body supporting plates 141 and 142, and the switch button 17 is mounted on the bottom 143 of the box. Thereafter, the screen body supporting plates 141 and 142 are fixed to the bottom 143 of the box, and the foot pads 18 are attached to the bottom 143 of the box. Finally, the cover 13 is mounted to the box body composed of the screen body supporting plates 141 and 142. It can be understood by a person skilled in the art that the above described installation process is merely illustrative.

The packing box provided in the exemplary embodiments of the present application by using at least one flexible display screen, can display a target frame and can display characters, frames, and the like to be presented by the gift giver on the flexible display screen, so that the gift giver can directly express his or her own kindness. An design concept, a wearing video etc. of the jewelry placed in the packing box, can be displayed on the flexible display screen, so that the jewelry can be known by customers, and sold easily by a seller. A frame, such as text or animation etc., with reminder function for an owner of the jewelry box can also be provided (For example, which day to wear the jewelry, reminding important matters, etc.), thereby adding functions of the box. In addition, by using at least one flexible display screen, at least one screen body supporting plate and the cover, the packing box can be made into a shape having more faces than a square, a rectangular etc. . . . Thus, the problem with limited aesthetics of the box caused by setting display screen only on the plane of the packing box can be avoided.

It should be noted that the above exemplary embodiments are only used to illustrate the technical solutions of the present application, and are not limited thereto. Although the application is described in detail with reference to the foregoing exemplary embodiments, it will be apparent to a person skilled in the art that the technical solutions described in the foregoing exemplary embodiments may be modified, or some of the technical features may be equivalently replaced; and the modifications or substitutions do not deviate from the spirit and scope of the technical solutions of the exemplary embodiments of the present application.

What is claimed is:

1. A packing box, comprising a box body and a display screen on the box body, the box body comprising a controller connected to the display screen; the display screen comprising at least one sub-display screen for displaying a target frame according to a control command received from the controller.

2. The packing box according to claim 1, wherein the box body comprises: at least one screen body supporting plate forming at least a part of an accommodation cavity, and the at least one screen body supporting plate is used for supporting the at least one sub-display screen.

3. The packing box according to claim 2, wherein the packing box further comprises: a cover arranged on the at least one screen body supporting plate.

4. The packing box according to claim 3, wherein the packing box further comprises: a decorative member arranged in the cover for placing an article.

5. The packing box according to claim 2, wherein the packing box further comprises: a decorative member arranged in the accommodation cavity for placing an article.

6. The packing box according to claim 2, wherein the at least one sub-display screen comprises a first sub-display screen and a second sub-display screen, the at least one screen body supporting plate comprises a first screen body supporting plate supporting the first sub-display screen and a second screen body supporting plate supporting the second sub-display screen.

7. The packing box according to claim 6, wherein the first screen body supporting plates and the second screen body supporting plate are connected end-to-end to form the box body, and a horizontal cross section of the box body is heart-shaped.

8. The packing box according to claim 2, wherein the packing box further comprises: a battery arranged in the accommodation cavity, and the battery supplies power to the at least one sub-display screen and the control module.

9. The packing box according to claim 2, wherein the packing box further comprises:
a communication circuit arranged in the accommodation cavity and receiving information related to the target frame, so that the controller controls the at least one sub-display screen to display the target frame according to the information related to the target frame.

10. The packing box according to claim 1, wherein the packing box further comprises:
a switch button arranged on the box body, and the switch button controls display states of the at least one sub-display screen.
